(19) United States
(12) Patent Application Publication
(10) Pub. No.: US 2018/0327573 A1
(43) Pub. Date: Nov. 15, 2018

(54) RUBBER WITH SILICA AND TRIETHANOLAMINE AND TIRE WITH COMPONENT

(71) Applicant: The Goodyear Tire & Rubber Company, Akron, OH (US)

(72) Inventors: George Jim Papakonstantopoulos, Medina, OH (US); Bruce Raymond Hahn, Hudson, OH (US)

(21) Appl. No.: 15/591,596

(22) Filed: May 10, 2017

(51) Int. Cl. C08L 9/00; C08L 9/06

(52) U.S. Cl. CPC C08L 9/00; C08L 2205/02; C08L 9/06

(57) ABSTRACT

This invention relates to a precipitated silica reinforced rubber composition which contains triethanolamine. The invention further relates to a tire with a component comprised of such rubber composition, such as for example, a tread.

This invention relates to a precipitated silica reinforced rubber composition which contains triethanolamine. The invention further relates to a tire with a component comprised of such rubber composition, such as for example, a tread.

### BACKGROUND OF THE INVENTION

Rubber stiffness for a precipitated silica reinforced rubber component for a tire, such as for example a tire tread, is often desired to promote better tire and associated vehicle handling and related performance for a tire. Lower hysteresis together with rubber stiffness is often desired to promote reduced internal heat generation within the tread during tire service with associated beneficially reduced temperature buildup to thereby promote tire durability.

Predictive rubber stiffness is often evidenced by the rubber's storage modulus (G′). An increased modulus (G′) is indicative of increased stiffness for the rubber composition.

Predictive rubber hysteresis is often evidenced by one or more of its rebound and tangent delta (tan delta) physical properties. An increased rebound and/or decreased tan delta property is indicative of beneficially reduced hysteresis for the rubber composition.

As indicated, promoting an increase in stiffness for a rubber composition such as for a tire tread to thereby beneficially promote tire handling while substantially maintaining or even beneficially reducing the rubber composition's hysteresis is often difficult to accomplish. Indeed, increasing stiffness of a rubber composition might be expected to also increase rather than decrease hysteresis of the rubber composition.

Low hysteresis is often desired for a tire tread rubber composition to promote reduced internal heat generation within the tread during tire service to thereby promote tire durability.

A challenge is therefore undertaken to evaluate promoting a beneficial increase in stiffness of a precipitated silica reinforced rubber composition while desirably promoting a beneficial decrease in its hysteresis.

To meet such significant challenge, it is desired to evaluate providing an additive comprised of triethanolamine to a precipitated silica reinforcement-containing rubber composition.

In the description of this invention, the terms “compounded” rubber compositions and “compounds” are used to refer to rubber compositions which have been compounded, or blended, with appropriate rubber compounding ingredients. The terms “rubber” and “elastomer” may be used interchangeably unless otherwise indicated. The amounts of materials are usually expressed in parts of material per 100 parts of rubber by weight (phr).

### SUMMARY AND PRACTICE OF THE INVENTION

In accordance with this invention, a rubber composition is provided which contains, based on parts by weight per 100 parts by weight elastomer (phr):

(A) elastomer(s) comprised of at least one sulfur curable conjugated diene-based elastomer, and

(B) about 25 to about 150, alternately from about 40 to about 110, phr of reinforcing filler comprised of rubber reinforcing carbon black and precipitated silica together with silica coupler for said precipitated silica having a moiety reactive with hydroxyl groups (e.g. silanol groups) on said precipitated silica and another different moiety interactive with said conjugated diene-based elastomer(s), and

(C) about 0.1 to about 10, alternately from about 0.25 to about 6 phr of triethanolamine.

In one embodiment, the said rubber composition contains up to about 6 phr of said rubber reinforcing carbon black and thereby only minimal amount of said carbon black and a maximum of precipitated silica reinforcement.

In one embodiment, the said rubber composition contains about 35 to about 50 phr of said rubber reinforcing carbon black and thereby at least about 35 phr of said carbon black to both provide reinforcement for the rubber composition and, also, to promote electrical conductivity for the rubber composition.

In one embodiment, the said rubber composition contains from about 6 to about 35 phr of said rubber reinforcing carbon black to provide an intermediate level of carbon black reinforcement for the rubber composition.

In one embodiment, the said precipitated silica and silica coupler are provided as a composite of precipitated silica with silica coupler reacted in situ within the rubber composition.

In one embodiment, the said precipitated silica and silica coupler are provided as a composite of precipitated silica with silica coupler pre-reacted prior to addition of the composite to said rubber composition.

In one embodiment, where the said precipitated silica with silica coupler are provided as a pre-reacted composite thereof prior to addition of said composite to said rubber composition, at least one of additional precipitated silica and additional silica coupler is added to said rubber composition.

In further accordance with this invention, a tire is provided having a component comprised of such rubber composition such as, for example, a circumferential rubber tread.

In practice, sulfur curable rubber compositions are normally prepared by a combination of preparatory non-productive (NP) mixing of sulfur curable elastomer(s) and associated compounding ingredients in one or more non-productive mixing steps followed by productive (P) mixing of sulfur and associated sulfur curing ingredients with the rubber composition. For an individual non-productive mixing step, the rubber compositions may be mixed in an internal rubber mixer while the temperature of the rubber mixture autogeneously increases to a desired temperature such as, for example, from about 140° C. to about 170° C. and the rubber mixture then dumped from the mixer.

Where the rubber composition contains a combination of precipitated silica and silica coupler for the silica, the precipitated silica and coupler are reactive with each other during the non-productive mixing step to form a composite thereof. In practice, sometimes when such rubber composition reaches a desired temperature during such internal non-productive rubber mixing, the mixing is allowed to continue for an additional brief period of time (e.g. such as for example about one to about four minutes) upon reaching the desired temperature, and within 10° C. of such desired mixing temperature, to aid in facilitating the reaction of the precipitated silica and coupler. Such extended non-productive mixing at a substantially constant or limited range of temperature may sometimes be referred to as “heat treatment” and the resultant rubber composition may sometimes be referred to as a “heat treated” rubber composition.

Therefore, in further accordance with the invention, a rubber composition is prepared by the sequential steps of, based on parts by weight per 100 parts by weight rubber (phr):

(A) thermomechanically mixing in at least one preparatory mixing step (e.g. in an internal rubber mixer), in the absence of sulfur and sulfur vulcanization accelerator at a temperature reaching a maximum in a range of from about 140° C. to about 170° C. a rubber composition comprised of:
(1) at least one sulfur curable diene-based elastomer,
(2) about 25 to about 150, alternately from about 40 to about 110, phr of reinforcing filler comprised of rubber reinforcing carbon black and precipitated silica together with silica coupler for said precipitated silica having a moiety reactive with hydroxyl groups (e.g. silanol groups) on said precipitated silica and another different moiety interactive with said conjugated diene-based elastomer(s), and
(3) about 0.1 to about 25, alternately from about 0.2 to about 6 phr of triethanolamine,

wherein said rubber composition at least one of said preparatory rubber steps upon reaching a maximum temperature (by thermomechanically mixing) in a range of from about 140° C. to about 170° C. is mixed (is heat treated) for a for a period of from about 1 to about 4 minutes at a temperature within about 10° C. of such maximum temperature, followed by:

(B) mixing sulfur and at least one sulfur vulcanization accelerator with said preparatory rubber composition at a temperature in a range of from 100° C. to about 120° C.

In additional accordance with this invention the resulting rubber composition is shaped and sulfur cured to form a tire tread.

In further accordance with the method of this invention, the resulting rubber composition is provided as a shaped rubber strip wherein the shaped rubber strip is applied to a tire carcass to form a circumferential rubber tread to form a tire assembly and the rubber tread of the tire assembly is sulfur cured.

In one embodiment of said method, said rubber composition contains up to about 6 phr of said rubber reinforcing carbon black and thereby only minimal amount of said carbon black and a maximum of precipitated silica reinforcement.

In one embodiment of said method, said rubber composition contains about 35 to about 50 phr of said rubber reinforcing carbon black and thereby at least about 35 phr of said carbon black to both provide reinforcement for the rubber composition and, also, to promote electrical conductivity for the rubber composition.

In one embodiment of said method, said rubber composition contains from about 6 to about 35 phr of said rubber reinforcing carbon black to provide an intermediate level of carbon black reinforcement for the rubber composition.

In additional accordance with this invention, a rubber composition is provided prepared by such method.

In further accordance with this invention, a tire is provided having a component comprised of such rubber composition such as, for example, a circumferential tire tread.

Said diene-based elastomer(s) for the rubber composition may be comprised of, for example, at least one of polybutadiene rubber (e.g. cis 1,4-polybutadiene rubber), styrene/butadiene rubber (SBR), synthetic cis 1,4-polyisoprene rubber and 3,4-polyisoprene rubber. In one embodiment, the styrene/butadiene rubber may be a functionalized (e.g. end functionalized) styrene/butadiene rubber (functionalized SBR) containing at least one functional group reactive with said precipitated silica. In one embodiment, said functional groups may be comprised of, for example, at least one of siloxy, amine and thiol groups. Said functional groups may be reactive with hydroxyl groups (e.g. silanol groups) on said precipitated silica or have a significant affinity for the precipitated silica itself.

In one embodiment, said styrene/butadiene rubber or functionalized styrene/butadiene rubber is tin or silicon coupled.

Said additional diene-based elastomers are not intended to include isobutylene based copolymers with various dienes such as, for example, isobutylene based butyl rubbers.

In practice, said silica coupler may be comprised of:

(A) bis(3-trialkoxysilylalkyl) polysulfide having an average of from 2 to about 4 connecting sulfur atoms in its polysulfidic bridge, or

(B) alkoxyorganomercaptosilane.

In one embodiment, said bis(3-trialkoxysilylalkyl) polysulfide is comprised of bis(3-triethoxysilylpropyl) polysulfide.

It is appreciated that such silica coupler may be interactive with both hydroxyl groups of said precipitated silica and with said triethanolamine to thereby create a complex structured rubber reinforcement.

Representative examples of conventional rubber reinforcing carbon blacks (non-oxidized rubber reinforcing carbon blacks) are, for example and not intended to be limiting, referenced in The Vanderbilt Rubber Handbook, 13^{th} edition, 1990, on Pages 417 and 418 with their ASTM designations. Such rubber reinforcing carbon blacks may have iodine absorptions ranging from, for example and not intended to be limiting, 60 to 240 g/kg and DBP values ranging from, for example and not intended to be limiting, 34 to 150 cc/100 g.

It is readily understood by those having skill in the art that the vulcanizable rubber composition would be compounded by methods generally known in the rubber compounding art. In addition, said compositions could also contain fatty acid, zinc oxide, waxes, antioxidants, antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Usually it is desired that the sulfur-vulcanizing agent is elemental sulfur. The sulfur-vulcanizing agent may be used in an amount ranging, for example, from about 0.5 to 8 phr, with a range of from 1.5 to 6 phr being often preferred.

The rubber composition may also contain petroleum based rubber processing oil and/or vegetable triglyceride oil (e.g. comprised of at least one of soybean, sunflower, rapeseed and canola oil).

Typical amounts of antioxidants may comprise, for example, about 1 to about 5 phr thereof. Representative antioxidants may be, for example, diphenyl-p-phenylenediamine and others, such as, for example, those disclosed in The Vanderbilt Rubber Handbook (1978), Pages 344 through 346. Typical amounts of antiozonants may comprise, for example, about 1 to 5 phr thereof. Typical amounts of fatty acids, if used, which can include stearic acid, comprise about 0.5 to about 3 phr thereof. Typical amounts of zinc oxide may comprise, for example, about 2 to about 5 phr thereof. Typical amounts of waxes comprise about 1 to about 5 phr thereof. Often microcrystalline waxes are used. Typical amounts of peptizers, when used, may be used in amounts of, for example, about 0.1 to about 1 phr thereof. Typical peptizers may be, for example, pentachlorothiophenol and dibenzamidodiphenyl disulfide.

Sulfur vulcanization accelerators are used to control the time and/or temperature required for vulcanization and to improve the properties of the vulcanizate. In one embodiment, a single accelerator system may be used, i.e., primary accelerator. The primary accelerator(s) may be used in total amounts ranging, for example, from about 0.5 to about 4, sometimes desirably about 0.8 to about 1.5, phr. In another embodiment, combinations of a primary and a secondary accelerator might be used with the secondary accelerator being used in smaller amounts, such as, for example, from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, sulfenamides, and xanthates. Often desirably the primary accelerator is a sulfenamide. If a second accelerator is used, the secondary accelerator is often desirably a guanidine such as for example a diphenylguanidine.

The mixing of the vulcanizable rubber composition can be accomplished by methods known to those having skill in the rubber mixing art. For example, the ingredients are typically mixed in at least two stages, namely at least one non-productive stage followed by a productive mix stage. The final curatives, including sulfur-vulcanizing agents, are typically mixed in the final stage which is conventionally called the “productive” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions and the volume and nature of the components. For example, the thermomechanical working may be from 1 to 20 minutes.

Vulcanization of the pneumatic tire containing the tire tread of the present invention is generally carried out at conventional temperatures in a range of, for example, from about 125° C. to 200° C. Often it is desired that the vulcanization is conducted at temperatures ranging from about 150° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The following examples are presented for the purposes of illustrating and not limiting the present invention. The parts and percentages are parts by weight, usually parts by weight per 100 parts by weight rubber (phr) unless otherwise indicated.

### EXAMPLE

In this example, exemplary rubber compositions for a tire tread were prepared for evaluation for use of triethanolamine in combination with reinforcing filler comprised of precipitated silica.

Control rubber compositions were prepared as Control rubber Samples A and B with diene-based elastomer(s) containing reinforcing filler comprised of precipitated silica and conventional rubber reinforcing carbon black together with silica coupler for the precipitated silica.

Experimental rubber compositions C and D are provided as being prepared in the manner of Control rubber Samples A and B except that they contained triethanolamine.

Control rubber Sample A and Experimental rubber Sample C were heat treated during their preparatory mixing.

The rubber compositions are illustrated in the following Table 1.

TABLE 1

| | Parts by Weight, rounded (phr) | | | |
|---|---|---|---|---|
| | Control | | Experimental | |
| | Sample A | | Sample C | |
| Material | (heat treated) | Sample B | (heat treated) | Sample D |
| Non-Productive Mixing (NP) | | | | |
| Cis 1,4-polybutadiene rubber¹ | 30 | 30 | 30 | 30 |
| Styrene/butadiene rubber² | 70 | 70 | 70 | 70 |
| Precipitated silica³ | 65 | 65 | 65 | 65 |
| Silica coupling agent⁴ | 5.2 | 5.2 | 5.2 | 5.2 |
| Rubber reinforcing carbon black (N330)⁵ | 5 | 5 | 5 | 5 |
| Petroleum based rubber processing oil⁶ | 20 | 20 | 20 | 20 |
| Zinc oxide | 2 | 2 | 2 | 2 |
| Fatty acids⁷ | 3 | 3 | 3 | 3 |
| Antioxidant | 3 | 3 | 3 | 3 |
| Wax, microcrystalline | 1.5 | 1.5 | 1.5 | 1.5 |
| Triethanolamine⁸ | 0 | 0 | 2 | 2 |
| Productive Mixing (P) | | | | |
| Sulfur | 1.5 | 1.5 | 1.5 | 1.5 |
| Sulfur cure accelerators⁹ | 3.5 | 3.5 | 3.5 | 3.5 |

¹Cis 1,4-polybutadiene rubber as BUD1207 ™ from The Goodyear Tire & Rubber Company having a Tg of about −102° C.
²Styrene/butadiene rubber as Solflex16452 from The Goodyear Tire & Rubber Company having a styrene content of about 16 percent with a Tg of about −42° C.
³Precipitated silica as Zeosil 1165 from Solvay
⁴Silica coupler comprised of a bis(3-triethoxysilylpropyl) polysulfide containing an average in a range of from about 2 to about 2.6 connecting sulfur atoms in its polysulfidic bridge as Si266 from Evonik
⁵Rubber reinforcing carbon black as N330, an ASTM classification
⁶Petroleum based rubber processing oil as Hyprene 100 from Ergon Refining
⁷Fatty acids comprised of stearic, palmitic and oleic acids
⁸Triethanolamine from Alfa Aesar
⁹Sulfur cure accelerators as sulfenamide primary accelerator and diphenylguanidine secondary accelerator

The rubber samples were prepared by sequential mixing steps in an internal rubber mixer comprised of non-productive (NP) mixing step(s) to an autogeneously generated mixing temperature of about 160° C. without sulfur curatives followed by a productive (P) mixing step in which sulfur and sulfur cure accelerator(s) were added to an autogeneously generated mixing temperature of about 110° C. The rubber compositions were allowed to cool between mixing steps. In general, such combination of sequential nonproductive and final productive mixing of rubber compositions is well known to those having skill in such art.

For preparation of Control rubber Sample A and Experimental rubber Sample C the non-productive mixing was continued for about 2 minutes at a temperature of about 160° C. after reaching the about 160° C. temperature. Such continued mixing of the uncured rubber compositions at the elevated temperature is referred to as heat treatment and the uncured rubber compositions may be referred to as heat treated rubber compositions.

Such heat treatment is not applied to the preparation of Control Rubber Sample B and Experimental rubber Sample D for which its non-productive mixing was provided for about four minutes to autogeneously generate an increase in mixing temperature of the rubber composition to about 160° C.

The following Table 2 illustrates cure behavior and various physical properties of rubber compositions based upon the basic formulation of Table 1 and reported herein as Control rubber Samples A and B and Experimental rubber Samples C through D. Where cured rubber samples are reported, such as for the stress-strain, rebound and DIN abrasion resistance values, the rubber samples were cured for about 14 minutes at a temperature of about 160° C.

TABLE 2

| | Parts by Weight (phr) | | | |
|---|---|---|---|---|
| | Control | | Experimental | |
| | Sample A | | Sample C | |
| | (heat treated) | Sample B | (heat treated) | Sample D |
| Material | | | | |
| Cis 1,4-polybutdiene rubber | 70 | 70 | 70 | 70 |
| Styrene/butadiene rubber | 30 | 30 | 30 | 30 |
| Triethanolamine | 0 | 0 | 2 | 2 |
| Properties | | | | |
| Stiffness of Cured Rubber (RPA Test) Test | | | | |
| Conditions: 1 Hertz, 1% strain, 60° C., (MPa) | | | | |
| Storage modulus (G′), (higher is better) | 2774 | 3764 | 3198 | 3970 |
| Hysteresis Predictive | | | | |
| Tan delta, RPA¹, 1% strain, 60° C. | 0.123 | 0.124 | 0.115 | 0.109 |
| (lower is better) | | | | |
| Additional properties | | | | |
| Tensile strength, ultimate (MPa) | 15.7 | 16.5 | 16.0 | 14.7 |
| Elongation at break (%) | 479.4 | 548.1 | 416.1 | 396.9 |
| Modulus (ring) 300% (MPa) | 8.4 | 7.5 | 10.3 | 10.2 |
| DIN abrasion resistance² (higher is better) | 100 | 102 | 123 | 130 |

¹ RPA test: test of rubber samples with Rubber Process Analyzer instrument which is an instrument for determining various viscoelastic properties of rubber samples including storage modulus (G′) and tangent delta (tan delta) physical properties at various temperatures and frequencies at various torsions sometimes referred to as “percent strains” (dynamic elongations).
²The DIN abrasion resistance value (ASTM D5963, DIN 53516) is normalized to a value of 100 for rubber Sample A and the abrasion resistance values for rubber Samples B, C and D are reported relative to the normalized value of 100 for rubber Sample A

From Table 2 it is observed that:

(A1) Stiffness of Heat Treated Cured Rubber at Low Strain (1 percent Strain)

For the heat treated rubber compositions of Control rubber Sample A and Experimental rubber Sample C, addition of triethanolamine for Experimental rubber Sample C is observed to increase the stiffness (G′) at low strain (1 percent) of the cured rubber composition to a value of 3198 kPa compared to a lower value of 2774 kPa for Control rubber Sample A. Therefore, it is concluded that it was discovered that the addition of triethanolamine significantly improved the stiffness of the heat treated rubber composition at the low strain.

### (A2) Stiffness of Non Heat Treated Cured Rubber at Low Strain

For the non heat treated rubber compositions of Control rubber Sample B and Experimental rubber Sample D, addition of triethanolamine for Experimental rubber Sample D is observed to increase the stiffness (G′) at low strain of the cured rubber composition to a value of 3970 kPa compared to a lower value of 3764 kPa for Control rubber Sample B. Therefore, it is concluded that the addition of triethanolamine significantly and beneficially improved the stiffness of the non-heat treated rubber composition at the low strain.

### (B1) Hysteresis for Heat Treated Rubber

For the heat treated Experimental rubber Sample C, the (60° C.) tan delta value of 0.115 was beneficially lower than the respective tan delta value of 0.123 at 1% strain for heat treated Control rubber Sample A. Therefore, it is concluded that the addition of the triethanolamine can beneficially decrease the hysteresis for the heat treated rubber.

### (B2) Hysteresis for Non-Heat Treated Rubber

For the non heat treated Experimental rubber Sample D, the (60° C.) tan delta value of 0.109 at 1percent strain for the non-heat treated Experimental rubber Sample D was significantly lower than the respective tan delta values of 0.124 at 1 percent strain for the non-heat treated Control rubber Sample A. Therefore, it is concluded that the addition of the triethanolamine significantly and beneficially improved (reduced) the hysteresis of the non-heat treated rubber composition which indicates a lower internal heat generation would be expected for the rubber composition when used as a tire tread during the tire service with a predictive beneficially improvement (reduction) in rolling resistance for the tire.

### (C) Abrasion Resistance

For Experimental heat treated rubber Sample C, the DIN abrasion resistance was beneficially 23 percent higher than the heat treated Control rubber Sample A. Also, for Experimental non-heat treated rubber Sample D the DIN abrasion resistance was beneficially approximately 27 percent higher than non-heat treated Control rubber sample B. Therefore, it is concluded that the addition of the triethanolamine improved the abrasion resistance of the heat treated and non-heat treated Control rubber compositions.

A significant discovery is therefore evident by addition of the triethanolamine to the precipitated silica reinforced rubber composition. The discovery is the beneficial increase in the cured stiffness while also providing a beneficial decrease in the hysteresis and beneficial increase in the abrasion resistance of the precipitated silica reinforced rubber composition.

While certain representative embodiments and details have been shown for the purpose of illustrating the invention, it will be apparent to those skilled in this art that various changes and modifications may be made therein without departing from the spirit or scope of the invention.

What is claimed is:

1. A rubber composition comprised of, based on parts by weight per 100 parts by weight elastomer (phr):
(A) elastomer(s) comprised of at least one sulfur curable conjugated diene-based elastomer,
(B) about 25 to about 150 phr of reinforcing filler comprised of precipitated silica and rubber reinforcing carbon black together with silica coupler for said precipitated silica having a moiety reactive with hydroxyl groups (e.g. silanol groups) on said precipitated silica and another different moiety interactive with said conjugated diene-based elastomer(s), and
(C) about 0.1 to about 25 phr of triethanolamine.

2. The rubber composition of claim 1 wherein said rubber composition contains up to about 6 phr of said rubber reinforcing carbon black.

3. The rubber composition of claim 1 wherein said rubber composition contains about 35 to about 50 phr of said rubber reinforcing carbon black.

4. The rubber composition of claim 1 wherein said rubber composition contains about 6 to about 35 phr of said rubber reinforcing carbon black.

5. The rubber composition of claim where said precipitated silica with silica coupler are provided as a composite of said precipitated silica and silica coupler reacted together in situ within the rubber composition.

6. The rubber composition of claim 1 where said precipitated silica with silica coupler are provided as a composite of precipitated silica and silica coupler pre-reacted prior to addition of said composite to said rubber composition.

7. The rubber composition of claim 1, where said precipitated silica with silica coupler are pre-reacted to form a composite thereof prior to addition to said rubber composition, at least one of additional precipitated silica and additional silica coupler is added to said rubber composition.

8. The rubber composition of claim 1 wherein said conjugated diene-based elastomer is comprised of at least one of polybutadiene rubber, styrene/butadiene rubber, synthetic cis 1,4-polyisoprene rubber and 3,4-polyisoprene rubber.

9. The rubber composition of claim 2 wherein said styrene/butadiene rubber is a functionalized styrene/butadiene rubber containing functional groups reactive with hydroxyl groups of said precipitated silica.

10. The rubber composition of claim 9 wherein styrene/butadiene rubber is end functionalized with said functional groups comprised of at least one of siloxy, amine and thiol groups.

11. The rubber composition of claim 2 wherein said styrene/butadiene rubber is tin or silicon coupled.

12. The rubber composition of claim 9 wherein said functionalized styrene/butadiene rubber is tin or silicon coupled.

13. The rubber composition of claim 1 wherein said silica coupler is comprised of:
(A) bis(3-trialkoxysilylalkyl) polysulfide having an average of from 2 to about 4 connecting sulfur atoms in its polysulfidic bridge, or
(B) alkoxyorganomercaptosilane.

14. The rubber composition of claim 1 wherein said silica coupler is comprised of bis(3-triethoxysilylpropyl) polysulfide having an average of from 2 to about 4 connecting sulfur atoms in its polysulfidic bridge.

15. A tire having a component comprised of the rubber composition of claim 1.

16. A tire having a circumferential tread comprised of the rubber composition of claim 1.

17. A method of preparing a rubber composition comprises the sequential steps of, based on parts by weight per 100 parts by weight rubber (phr):
(A) thermomechanically mixing in at least one preparatory mixing step, in the absence of sulfur and sulfur vulcanization accelerator at a temperature reaching a maximum in a range of from about 140° C. to about 170° C. a rubber composition containing:
(1) at least one sulfur curable diene-based elastomer,
(2) about 25 to about 150 phr of reinforcing filler comprised of rubber reinforcing carbon black and precipitated silica together with silica coupler for said precipitated silica having a moiety reactive with hydroxyl groups on said precipitated silica and another different moiety interactive with said conjugated diene-based elastomer(s), and
(3) about 0.1 to about 25 phr of triethanolamine,
wherein said rubber composition of at least one of said preparatory rubber steps, upon reaching a maximum temperature in a range of from about 140° C. to about 170° C., is mixed for a period of from about 1 to about 4 minutes at a temperature within about 10° C. of such maximum temperature, followed by:
(B) mixing sulfur and at least one sulfur vulcanization accelerator with said preparatory rubber composition at a temperature in a range of from 100° C. to about 120° C., sulfur and at least one sulfur cure accelerator.

18. The method of claim 17 wherein the rubber composition is shaped and sulfur cured to form a tire tread.

19. The method of claim 17 wherein the rubber composition is shaped to form a rubber strip wherein the shaped rubber strip is applied to a tire carcass to form a circumferential rubber tread and thereby form a tire assembly and the rubber tread of the tire assembly is sulfur cured.

20. A tire having a circumferential tread comprised of the rubber composition prepared by the method of claim 17.
